(19) United States
(12) Patent Application Publication
(10) Pub. No.: US 2018/0073550 A1
(43) Pub. Date: Mar. 15, 2018

(54) SHAFT ELEMENT, METHOD FOR PRODUCING A SHAFT ELEMENT COMPOSED OF TWO DIFFERENT MATERIALS, AND CORRESPONDING TURBOMACHINE

(71) Applicant: Siemens Aktiengesellschaft, Munich (DE)

(72) Inventors: Torsten-Ulf Kern, Wesel (DE); Stefan Brußk, Mülheim an der Ruhr (DE); Karsten Niepold, Mülheim (DE)

(73) Assignee: Siemens Aktiengesellschaft, Munich (DE)

(21) Appl. No.: 15/558,766

(22) PCT Filed: Mar. 16, 2016
(86) PCT No.: PCT/EP2016/055635

§ 371 Date: Sep. 15, 2017

(30) Foreign Application Priority Data
Mar. 23, 2015 (EP) 15160284.4

(51) Int. Cl. F16C 3/02; F01D 5/02; B23K 9/025; B23K 9/23; B23K 9/235

(52) U.S. Cl. CPC F16C 3/023; F01D 5/02; B23K 9/025; B23K 9/232; B23K 2201/001; F05D 2220/31; F05D 2230/232; F05D 2240/60; B23K 9/235

(57) ABSTRACT

A shaft element of a turbomachine, in particular of a combined steam turbine, having at least two shaft subsegments integrally joined to each other by means of a weld, wherein different chemical and mechanical properties are inherent to the shaft subsegments, wherein the weld has a ratio of welding layer height to weld width of 1:14 to 1:2. A method produces a shaft element composed of two different materials having at least two shaft subsegments integrally joined to each other by means of a weld.

### CROSS REFERENCE TO RELATED APPLICATIONS

This application is the US National Stage of International Application No. PCT/EP2016/055635 filed Mar. 16, 2016, and claims the benefit thereof. The International Application claims the benefit of European Application No. EP15160284 filed Mar. 23, 2015. All of the applications are incorporated by reference herein in their entirety.

### FIELD OF INVENTION

The invention relates to a shaft element of a turbomachine, in particular of a combined steam turbine, having at least two shaft sub-portions that are joined together in a materially integral manner by means of a weld seam, in the case of which dissimilar chemical and mechanical properties are inherent to these shaft sub-portions.

The invention relates to a method for producing a shaft element that is composed of two dissimilar materials, in the case of which two shaft segments that are composed of dissimilar materials are joined together in a materially integral manner by means of a weld seam so as to form the shaft element.

The invention likewise relates to a turbomachine, in particular a combined steam turbine, having a shaft element that revolves about an axial axis and has two shaft sub-portions of dissimilar materials, which are interconnected in a materially integral manner by a weld seam.

### BACKGROUND OF INVENTION

Shaft elements of the generic type in turbomachines support blades that are disposed in a concentric manner about an axial rotation axis, or blade rings that are formed from said blades, respectively. A plurality of rows of blades can be disposed sequentially herein on one shaft element of this type.

Such a shaft element can extend axially through various part-regions of the turbomachine and herein be exposed to various thermal and mechanical influences.

The construction of the shaft element is to be explained in more detail, using the example of a combined steam turbine which in an exemplary manner comprises a medium-pressure turbine part and, downstream of the latter, a low-pressure turbine part.

This shaft element typically extends axially both through the medium-pressure turbine part as well as through the low-pressure turbine part of the combined steam turbine. For example, the shaft element by way of a first shaft sub-portion extends in the medium-pressure turbine part, and by way of a further shaft sub-portion extends in the low-pressure turbine part.

In terms of an operating medium that perfuses the combined steam turbine, both a high operating pressure as well as a higher operating temperature of the operating medium prevail in the medium-pressure turbine part than is the case in the low-pressure turbine part of the combined steam turbine. For example, the operating temperature of the operating medium in the region of the medium-pressure turbine part is more than 400° C.

To this extent, the first shaft sub-portion of the shaft element is also thermally stressed to a higher degree in this medium-pressure turbine part when the former interacts with the operating medium in said medium-pressure turbine part.

The further shaft sub-portion of the shaft element in the downstream low-pressure turbine part herein is indeed thermally stressed to a lesser degree but is mechanically stressed to a higher degree.

To this extent, it is desirable for the shaft sub-portions of the shaft element that are stressed in a dissimilar manner to have correspondingly adapted material properties.

It is favorable for the first shaft sub-portion in the region of the medium-pressure turbine part to be composed of a material that tends to be heat-resistant, whereas the further shaft sub-portion in the region of the low-pressure turbine part should rather be formed from a material that tends to be tough-at-cold-temperature.

An optimal profile of properties in terms of a shaft element that in the axial direction extends at least partially through the turbomachine and is produced in a monoblock design cannot always be implemented especially in a turbomachine such as specifically such a combined steam turbine having a medium-pressure turbine part and a low-pressure turbine part adjacent thereto, for example. This is substantially caused by the desired material properties being combined in the case of the monoblock design, on account of which compromises which preclude the optimal operation of the turbomachine, or of the combined steam turbine, respectively, have to be accepted in a disadvantageous manner, however.

Shaft elements of this type, by means of a suitable welding method, are therefore often joined together in a thermal manner from a plurality of shaft segments that are equipped with dissimilar properties.

Shaft-connecting welding of this type represents a useful alternative in order for materials having dissimilar chemical compositions and having dissimilar mechanical properties such as, in particular, “heat-resistant” and “tough-at-cold-temperature”, to be able to be joined together in a thermal manner.

However, the set of problems of the dissimilar material properties of these shaft segments requiring a special welded construction by way of a buffer weld, by means of which a heat-resistant shaft segment of a later first shaft sub-portion of the shaft element can be welded to a tough-at-cold-temperature shaft segment of a later further shaft sub-portion of the shaft element, for example, is not infrequently encountered. The buffer weld herein is preferably applied to the highly heat-resistant material of the heat-resistant shaft segment.

A procedure using a buffer weld is known from U.S. Pat. No. 4,962,586, for example.

A procedure of this type is indeed practicable in order for a shaft element such as of a combined steam turbine having various shaft sub-portions to be achieved, dissimilar properties being inherent to said shaft sub-portions.

However, said procedure also appears to be time-intensive and thus cost-intensive.

In order for the disadvantages in terms of an additional buffer weld of this type to be avoided, another method in the case of which such a buffer weld can be dispensed with on account of a targeted selection of material in terms of the shaft segments that are to be joined together in a thermal manner and on account of an adapted heat treatment is disclosed in WO 2004/051056 A1.

### SUMMARY OF INVENTION

It is an object of the invention to refine shaft elements of the generic type which are provided for use in a turbomachine and in particular known respective production methods while bypassing a buffer weld.

The object of the present invention is achieved by a shaft element of a turbomachine, in particular of a combined steam turbine, having at least two shaft sub-portions that are joined together in a materially integral manner by means of a weld seam, in the case of which dissimilar chemical and mechanical properties are inherent to these shaft sub-portions, wherein the weld seam has a weld pass height to weld seam width ratio of 1:14 to 1:2.

The present invention relates in particular to a shielded arc weld that is regulated by means of energy density in a narrow gap on steep flanks, by way of a targeted influence on the material property in the actual welded connection or the weld seam, respectively.

The shaft element of a turbomachine in portions is often stressed thermally and mechanically in a dissimilar manner, be it in a compressor region or in a turbine region of the turbomachine.

A shaft element of a combined steam turbine is particularly affected thereby when a high-pressure turbine part, a medium-pressure turbine part, and/or a low-pressure turbine part have a continuous shaft element which is surrounded by a flow of an operating medium that perfuses the combined steam turbine.

Combined steam turbines of this type have an inflow region and two or more sequentially disposed turbine parts that are configured so as to have blades and vanes.

The first shaft sub-portion of the shaft element herein in the region of the high-pressure turbine part, or of the medium-pressure turbine part, respectively, is for example thermally stressed to a higher degree than the further shaft sub-portion of the shaft element in the region of the low-pressure turbine part, for instance, etc.

For this reason, it is advantageous for this first shaft sub-portion to be designed with the aid of a comparatively more heat-resistant material.

By contrast, the further shaft sub-portion of the shaft element in the region of the low-pressure turbine part is subjected to higher mechanical stress than the first shaft sub-portion of the shaft element in the region of the high-pressure or medium-pressure turbine part, respectively.

To this extent, it is advantageous for the further shaft sub-portion to be produced from a comparatively more tough-at-cold-temperature material.

The same also applies in terms of the shaft sub-portions of the medium-pressure turbine part of the combined steam turbine in relation to the low-pressure turbine part of the combined steam turbine.

In any case, the welded connection of shaft sub-portions of dissimilar materials can presently be designed in a substantially better manner than has previously been the case.

To this extent, the object of the invention is also achieved by a method for producing a shaft element that is composed of two dissimilar materials, in the case of which two shaft segments that are composed of dissimilar materials are joined together in a materially integral manner by means of a weld seam so as to form the shaft element, wherein the weld seam is generated having a weld pass height/weld seam width ratio of 1:14 to 1:2.

The invention is distinguished in that the first of the at least two shaft sub-portions is produced from a heat-resistant material 1CrMoV, 2CrMoNiWV, 10CrMoWVNbN, 10CrMoVNbN or 9CrMoCoBNbN, or 9Cr3CoWNbBN, respectively.

The present invention relates in particular to a production method of a corresponding shaft element using the aid of a shielded arc weld in a partially martensitic region having a martensitic conversion rate of 70% to 80%, in order for two materials having dissimilar chemical and/or mechanical properties to be connected in a materially integral manner while bypassing the use of a buffer weld.

It is to be understood that the welded connection in the present narrow gap between the shaft segments that are to be joined together in a materially integral manner so as to form the shaft element can be refined in particular by the features hereunder.

A targeted control of the welded connection, or of the weld seam, respectively, in terms of the adjustment of properties of the materials that are to be mutually fused thus becomes possible in the thermal influence zone of the welding flanks and/or in the welded product per se on account of a refinement of the process management, process monitoring, and process handling, especially in the case of the present narrow-gap welding.

The shaft element herein can be configured in diverse ways. The shaft element is designed as a rotor part, for example.

A further variant of embodiment provides, for example, that the weld seam comprises a plurality of weld passes which in each case are generated by a single weld bead, so as to achieve a weld-pass heat treatment, in particular an intermediate-pass heat treatment, of the respective weld pass that lies therebelow, by way of the adjusted geometry of the respective weld bead. The welded connection, or the weld seam, respectively, that is generated between two dissimilar materials can also be significantly improved on account thereof. Solely on account of this construction of the weld pass of the weld seam, a shaft element of the generic type can be advantageously refined such that this feature is advantageous even without the remaining features of the invention.

To this extent, a method for producing a corresponding shaft element can be refined accordingly in that weld passes of the weld seam are generated by only a single weld bead, so as to achieve a weld-pass heat treatment, in particular an intermediate-pass heat treatment, of the respective weld pass that lies therebelow, by way of the adjusted geometry of the respective weld bead.

As has already been indicated above, the weld seam is advantageously configured in a narrow gap, on account of which the weld passes can in each case be readily generated by a single weld bead.

Both the present weld pass height/weld seam width ratio, as well as the construction of the weld passes in terms of the number of the required weld beads, in terms of construction and process technology can be positively achieved independently in the narrow gap, in particular.

For this reason alone, a further advantageous variant of embodiment provides that the weld seam comprises two axially opposite steep joint flanks which in each case in relation to a vertical have an opening angle of <1.5°, advantageously of <1°, so as to particularly positively control a penetration of an input of thermal energy. On account thereof, localized influencing of the material in the respective flank regions can be achieved in a particularly advantageous manner.

It has moreover been found that an excellent welded connection, or a weld seam, respectively, can be achieved in conjunction with selected materials.

The quality of the welded connection, or of the weld seam, respectively, to be generated can yet again be significantly improved when the further of the at least two shaft sub-portions is produced from a tough-at-cold-temperature material 2.0-4.0NiCrMoV, 2.0-4.0NiCrMoV Super Clean, or 2CrNiMo.

In particular the method that underlies the invention can be configured in an advantageous manner when one shaft segment prior to welding, at least in a region of a welding flank, is pre-heated to a pre-heating temperature between 100° C. and 350° C., advantageously between 150° C. and 300° C., in order for a distribution of the thermal flow to be improved. On account thereof, especially a reduction in the initial hardness in both materials of the shaft segments to be interconnected in a materially integral manner can be achieved.

Independently of the remaining features of the invention, it is also furthermore advantageous when the weld seam, in particular the individual weld beads of the weld passes, is/are generated by means of a welding rate of 30 mm/min to 450 mm/min, advantageously of 40 mm/min to 350 mm/min. The aforementioned heat-resistant and tough-at-cold-temperature materials in particular can be joined together in a particularly advantageous manner on account thereof.

Additionally or alternatively, it is particularly expedient for the weld seam, in particular the individual weld beads of the weld passes, to be generated by means of an energy input per unit length of 5 kJ/cm to 30 kJ/cm, since solely on account thereof, a positive influence can be produced on the weld seam that connects the two dissimilar materials, independently of the remaining features of the invention.

Further favorable action can be taken on the welded connection, or the weld seam, respectively, when the weld seam, in particular the individual weld beads of the weld passes, are subjected to a localized thermal treatment. The difference in dissimilar quality-related thermal post-treatments of the materials to be interconnected herein has a negligible role in terms of the properties of the present weld seam in the case of a temperature of up to 20 K below the tempering temperature of the more highly alloyed basic material that is additionally applied during a targeted adjustment of the properties.

On account of the invention described herein, a production process in terms of a shaft element is particularly well achieved, said production process by shielded arc welding having targeted controlling, and while adhering to defined parameters, setting the properties in the welded connection of a heat-resistant material and of a tough-at-cold-temperature material without a buffer weld.

To this extent, a buffer weld of this type can be dispensed with in the case of the embodiment of a welded shaft connection of a heat-resistant material, on the one hand, and a tough-at-cold-temperature material, on the other hand for dissimilar material combinations.

The object of the invention is also achieved by a turbomachine, in particular a combined steam turbine, having a shaft element that revolves about an axial axis and has two shaft sub-portions of dissimilar materials, which are interconnected in a materially integral manner by a weld seam, wherein the turbomachine is distinguished by a shaft element according to one of the features described herein, and/or wherein the shaft element is produced by a method according to one of the features described herein.

A turbomachine that is equipped with the present shaft element can be produced in a more cost-effective manner.

Further features, effects, and advantages of the present invention will be explained by means of the appended drawing and of the description hereunder, in which, for example, a shaft element designed according to the concept of the invention of an exemplary turbomachine is illustrated and described.

### BRIEF DESCRIPTION OF THE DRAWINGS

In the drawing:

FIG. 1 schematically shows a partial view of a shaft element of a steam turbine, in a transitional region between a medium-pressure turbine part and a low-pressure turbine part, having two shaft sub-portions which are composed of dissimilar materials and are joined together in a materially integral manner by means of a welded connection; and

FIG. 2 schematically shows the welded connection in a peripheral region of a first shaft segment of a heat-resistant material, and of a further shaft segment of a tough-at-cold-temperature material, of the shaft element shown in FIG. 1, wherein the first shaft segment configures the shaft sub-portion on the medium-pressure turbine part, and the further shaft segment configures the shaft sub-portion on the low-pressure turbine part.

### DETAILED DESCRIPTION OF INVENTION

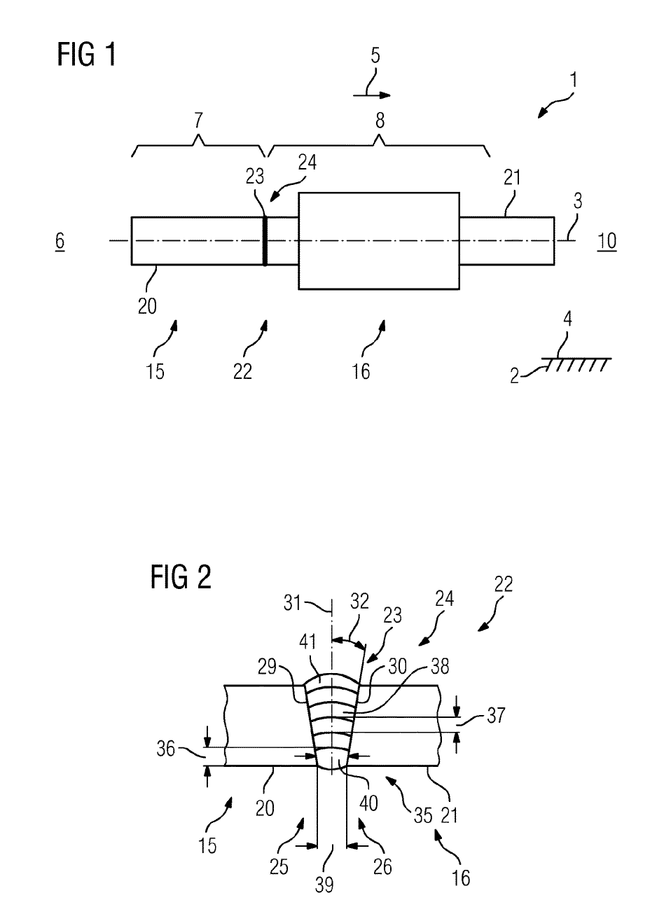

The shaft element 1 shown in FIG. 1 serves for receiving a multiplicity of blades (not illustrated), and is installed in such a manner in a turbomachine 2 (not shown in more detail) that said shaft element 1 during operation of the turbomachine 2 rotates about an axial rotation axis 3.

The turbomachine 2 in this exemplary embodiment is a combined steam turbine 4 (not shown in more detail) which is distinguished by a medium-pressure turbine part (not shown) and, adjacent downstream thereof, by a low-pressure turbine part (not shown).

The shaft element 1 in the axial direction 5 extends further along the axial rotation axis 3, from an entry region 6 of the combined steam turbine 4 through a medium-pressure region 7 of the combined steam turbine 4 by way of a low-pressure region 8 of the combined steam turbine 4 up to an exit region 10 of the combined steam turbine 4.

A first shaft portion 15 herein is located substantially in the medium-pressure region 7, and a further shaft portion 16 is disposed substantially in the low-pressure region 8, such that these shaft sub-portions 15 and 16 interact with an operating medium, largely super-heated steam, that perfuses the combined steam turbine 4 from the entry region 6 to the exit region 10.

The operating medium herein in the medium-pressure region 7 in particular has an operating temperature that is even higher than in the low-pressure region 8, such that the first shaft sub-portion 15 is thermally stressed to a higher degree than the further shaft sub-portion 16 of the shaft element 1.

However, the further shaft sub-portion 16 is mechanically stressed to a higher degree than the first shaft sub-portion 15 of the shaft element 1.

This necessitates that the first shaft portion 15 of the shaft element 1 should be produced from a material (not identified by a separate reference sign) that is more heat-resistant than that of the further shaft portion 16 of the shaft element 1.

The heat-resistant material used here is 1CrMoV.

Alternatively, however, the latter can also be replaced by one of the other heat-resistant materials 2CrMoNiWV, 10CrMoWVNbN, 10CrMoVNbN or 9CrMoCoBNbN, or 9Cr3Co3WNbBN, respectively.

Consequently, the further shaft portion 16 of the shaft element 1 should be produced from a material (not identified by a separate reference sign) that is tougher-at-cold-temperature than that of the first shaft portion 15 of the shaft element 1.

The tough-at-cold-temperature material used here is 2.0 NiCrMoV.

Alternatively, however, the latter can also be replaced by one of the other tough-at-cold-temperature materials 2.0-4.0NiCrMoV, 2.0-4.0NiCrMoV Super Clean, or 2CrNiMo.

In any case, the shaft element 1 is composed of a first shaft segment 20 (heat-resistant material) and of a further shaft segment 21 (tough-at-cold-temperature material), wherein the two different shaft segments are thermally joined, that is to say joined together in a materially integral manner by means of a welded connection 22.

FIG. 2 schematically and partially shows the construction of a weld seam 23 of the welded connection 22 by means of a peripheral region fragment 24 of the shaft element 1.

The welded connection 22, or the weld seam 23, respectively, is based on a narrow gap 25 between the first shaft segment 20 and the further shaft segment 21, the two latter being axially opposite one another and forming a welding joint 26.

Two joint flanks 29 and 30 which are formed by the shaft segments 20 and 21 are present on the welding joint 26, wherein each of the joint flanks 29 and 30 in relation to the vertical 31 has an opening angle 32 of only <1° (a merely exemplary indication). On account thereof, the effects of an undesirable thermal input into the neighboring material regions can be reduced. The opening angle 32 and thus the inclined positioning of the joint flanks, or of the welding flanks 29 and 30, respectively, herein are illustrated in an exaggerated manner.

The weld seam 23 that is configured according to the concept of the invention can now be further configured in an advantageous manner on the welding joint 26 thus prepared.

The weld seam 23 is distinguished in particular by a weld pass height/weld seam width ratio 35 of 1:14 to 1:2, wherein in the present case the weld pass height 36 is formulated by the thickness 37 of an individual weld bead 38, and the weld seam width 39 is formulated by the width 40 of the respective individual weld bead 38.

The weld pass height/weld seam width ratio 35 in this exemplary embodiment depends also on the joint width that varies in the direction of the vertical 31.

The thickness 37 of the weld pass height 36 herein is aligned in the direction of the vertical 31, and the width 40 of the weld seam width 39 extends transversely to this vertical 31.

A further particularity of the present welded connection 22, or of the weld seam 23, respectively, is derived in that each of the weld passes 41 has only a single weld bead 38. The heat treatment of the weld passes can thus be influenced in a particularly simple manner.

Each of the weld beads 38 herein in an exemplary manner has been generated at a welding rate of 100 mm/min at an energy input per unit length of 15 kJ/cm.

The welding flanks 29 and 30 herein in an exemplary manner have previously been pre-heated to a pre-heating temperature of 200° C., in order for an improved distribution of the thermal flow to be achieved.

While the invention has been illustrated and described in more detail by the preferred exemplary embodiment, the invention is not limited by this disclosed exemplary embodiment, and other variations can be derived therefrom by a person skilled in the art, without departing from the scope of protection of the invention.

1. A shaft element of a turbomachine or of a combined steam turbine, comprising:
at least two shaft sub-portions that are joined together in a materially integral manner by means of a weld seam, in the case of which dissimilar chemical and mechanical properties are inherent to these shaft sub-portions,
wherein the weld seam has a weld pass height/weld seam width ratio of 1:14 to 1:2,
wherein the first of the at least two shaft sub-portions is produced from a heat-resistant material 1CrMoV, 2CrMoV, 2CrMoNiWV, 10CrMoWVNbN, 10CrMoVNbN, 9CrMoCoBNbN, or 9Cr3Co3WNbBN.

2. The shaft element as claimed in claim 1,
wherein the weld seam comprises a plurality of weld passes which in each case are generated by a single weld bead, so as to achieve a weld-pass heat treatment, or an intermediate-pass heat treatment, of the respective weld pass that lies therebelow, by way of the adjusted geometry of the respective weld bead.

3. The shaft element as claimed claim 1,
wherein the weld seam comprises two axially opposite steep joint flanks which in each case in relation to a vertical have an opening angle of <1.5°, so as to positively control a penetration of an input of thermal energy.

4. The shaft element as claimed in claim 1,
wherein the further of the at least two shaft sub-portions is produced from a tough-at-cold-temperature material 2.0-4.0NiCrMoV, 2.0-4.0NiCrMoV Super Clean, or 2CrNiMo.

5. The shaft element as claimed in claim 1,
wherein the further of the at least two shaft sub-portions is produced from a low alloyed heat-resistant material 1CrMoV, 2CrMoV, or 2CrMoNiWV, and the second material is of the type 10CrMoWVNbN, 10CrMoVNbN, 9CrMoCoBNbN, or 9Cr3Co3WNbBN.

6. A method for producing a shaft element (1) that is composed of two dissimilar materials, comprising:
joining two shaft segments that are composed of dissimilar materials together in a materially integral manner by means of a weld seam so as to form the shaft element,
wherein the weld seam is generated having a weld pass height to weld seam width ratio of 1:14 to 1:2,
wherein the first of the at least two shaft sub-portions is produced from a heat-resistant material 1CrMoV, 2CrMoV, 2CrMoNiWV, 10CrMoWVNbN, 10CrMoVNbN, 9CrMoCoBNbN, or 9Cr3Co3WNbBN.

7. The method as claimed in claim 6,
wherein weld passes of the weld seam are generated by only a single weld bead, so as to achieve a weld-pass heat treatment, or an intermediate-pass heat treatment, of the respective weld pass that lies therebelow, by way of the adjusted geometry of the respective weld bead.

8. The method as claimed in claim 6,
wherein one shaft segment prior to welding, at least in a region of a welding flank, is pre-heated to a pre-heating temperature between 100° C. and 350° C., in order for a distribution of the thermal flow to be improved.

9. The method as claimed in claim 6,
wherein the weld seam, or the individual weld beads of the weld passes, is/are generated by means of a welding rate of 30 mm/min to 450 mm/min.

10. The method as claimed in claim 6,
wherein the weld seam, or the individual weld beads of the weld passes, is/are generated by means of an energy input per unit length of 5 kJ/cm to 30 kJ/cm.

11. The method as claimed in claim 6,
wherein the weld seam, or the individual weld beads of the weld passes are subjected to a localized thermal treatment.

12. A turbomachine comprising:
a shaft element as claimed in claim 1
wherein the shaft element revolves about an axial axis and has two shaft sub-portions of dissimilar materials, which are interconnected in a materially integral manner by a weld seam.

13. The shaft element as claimed in claim 3,
wherein the opening angle is <1°.

14. The method as claimed in claim 8,
wherein the pre-heating temperature is between 150° C. and 300° C.

15. The method as claimed in claim 9,
wherein the welding rate is 40 mm/min to 350 mm/min.

16. A turbomachine, comprising:
a shaft element that revolves about an axial axis and has two shaft sub-portions of dissimilar materials, which are interconnected in a materially integral manner by a weld seam,
wherein the shaft element is produced by the method of claim 6.
